(19) United States
(12) Patent Application Publication
(10) Pub. No.: US 2013/0013380 A1
(43) Pub. Date: Jan. 10, 2013

(54) Online Application Combining Election Service with Social Media for Voter-Candidate Matching

(76) Inventor: Jerry Brock BROWER, Hilo, HI (US)

(21) Appl. No.: 13/543,302

(22) Filed: Jul. 6, 2012

Related U.S. Application Data
(60) Provisional application No. 61/504,878, filed on Jul. 6, 2011.

(51) Int. Cl. G06Q 99/00

(52) U.S. Cl. 705/12

(57) ABSTRACT

An online application which combines election service with social media for voter-candidate matching includes a plurality of user accounts. The plurality of user accounts includes a plurality of voter accounts and a plurality of candidate accounts. Each of the user accounts includes a profile where the profile can be a voter profile or a candidate profile. The plurality of voter accounts is able to select a specific candidate profile from the candidate profiles, where the specific candidate profile includes a plurality of information. The plurality of user accounts also gets to compare different candidate profiles in order to gain a better understanding about the candidate profiles. The plurality of voter accounts and the plurality of candidate accounts are also able to gain a particular political view through a list of political questions, participate in daily political polls, participate in straw polls, and interact with other campaign related activities.

The current application claims a priority to the U.S. Provisional Patent application Ser. No. 61/504,878 filed on Jul. 6, 2011.

### FIELD OF THE INVENTION

The present invention relates generally to an online application and method of use thereof. More specifically, the application combines election services with social media to link voters to candidates they are interested in.

### BACKGROUND OF THE INVENTION

Voters can have a difficult time identifying candidates who share their interest. Even if voters know of candidates with similar views on issues, voters can have difficulty learning how to assist a candidate's campaign. Moreover, it is difficult to find information about multiple candidates, groups, etc. in one place. It is therefore an object of the present invention to provide a tool to link voters to candidates who have similar views. The present invention provides an application where the user can gain any necessary information about candidates, including how to directly interact with a candidate's campaign or form groups or political action committees (PACs).

Social media such as Facebook and Twitter are also very popular. These social media outlets provide a convenient medium for individuals to express their opinions about political issues and candidates. It is a further object of the present invention to provide a way to link the application to social media.

### BRIEF DESCRIPTION OF THE DRAWINGS

FIG. 1 is a flow chart illustrating the present invention from the perspective view of a voter account.

FIG. 2 is a flow chart illustrating the process of creating a specific voter account.

FIG. 3 is a flow chart illustrating the process of selecting and a comparing the candidate profiles by the specific voter account.

FIG. 4 is a flow chart illustrating the process of uploading the additional documents by the specific voter account.

FIG. 5 is a flow chart illustrating the process of the virtual debate from the perspective view of the specific voter account.

FIG. 6 is a flow chart illustrating the process of assigning the political view for the specific voter account.

FIG. 7 is a flow chart illustrating the process of displaying the daily poll resulting chart from the perspective view of the specific voter account.

FIG. 8 is a flow illustrating the process of displaying the straw poll resulting chart from the perspective view of the specific voter account.

FIG. 9 is a flow chart illustrating the campaign activities from the perspective view of the specific voter account.

FIG. 10 is a flow chart illustrating the present invention from the perspective view of a candidate account.

FIG. 11 is a flow chart illustrating the process of creating a specific candidate account.

FIG. 12 is a flow chart illustrating the process of selecting and the comparing a second candidate profile by the specific candidate account.

FIG. 13 is a flow chart illustrating the process of uploading the additional documents by the specific candidate account.

FIG. 14 is a flow chart illustrating the process of the virtual debate from the perspective view of the specific candidate account.

FIG. 15 is a flow chart illustrating the process of assigning the political view for the specific candidate account.

FIG. 16 is a flow chart illustrating the process of displaying the daily poll resulting chart from the perspective view of the specific candidate account.

FIG. 17 is a flow illustrating the process of displaying the straw poll resulting chart from the perspective view of the specific candidate account.

FIG. 18 is a flow chart illustrating the campaign activities and campaign management tools from the perspective view of the specific candidate account.

### DETAIL DESCRIPTIONS OF THE INVENTION

All illustrations of the drawings are for the purpose of describing selected versions of the present invention and are not intended to limit the scope of the present invention.

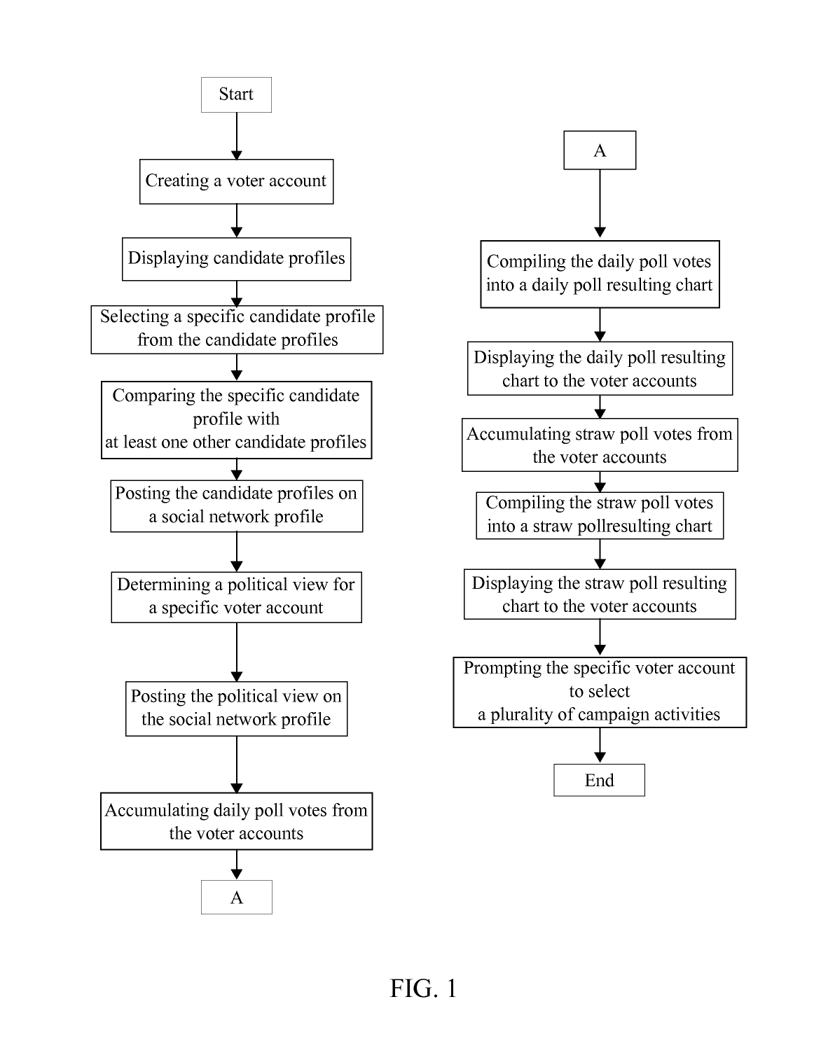

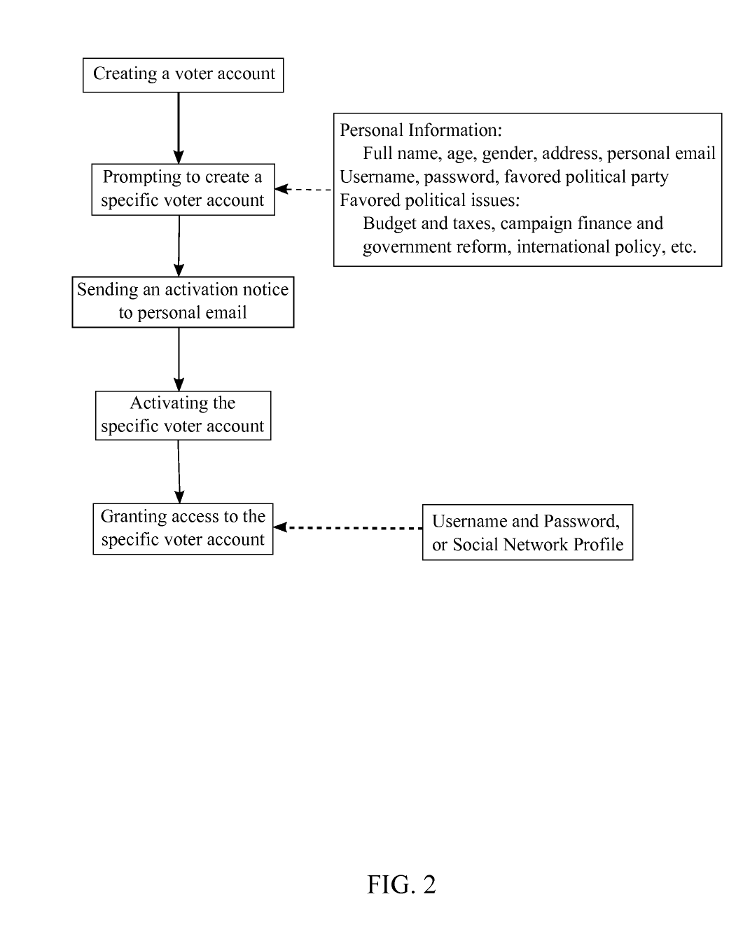

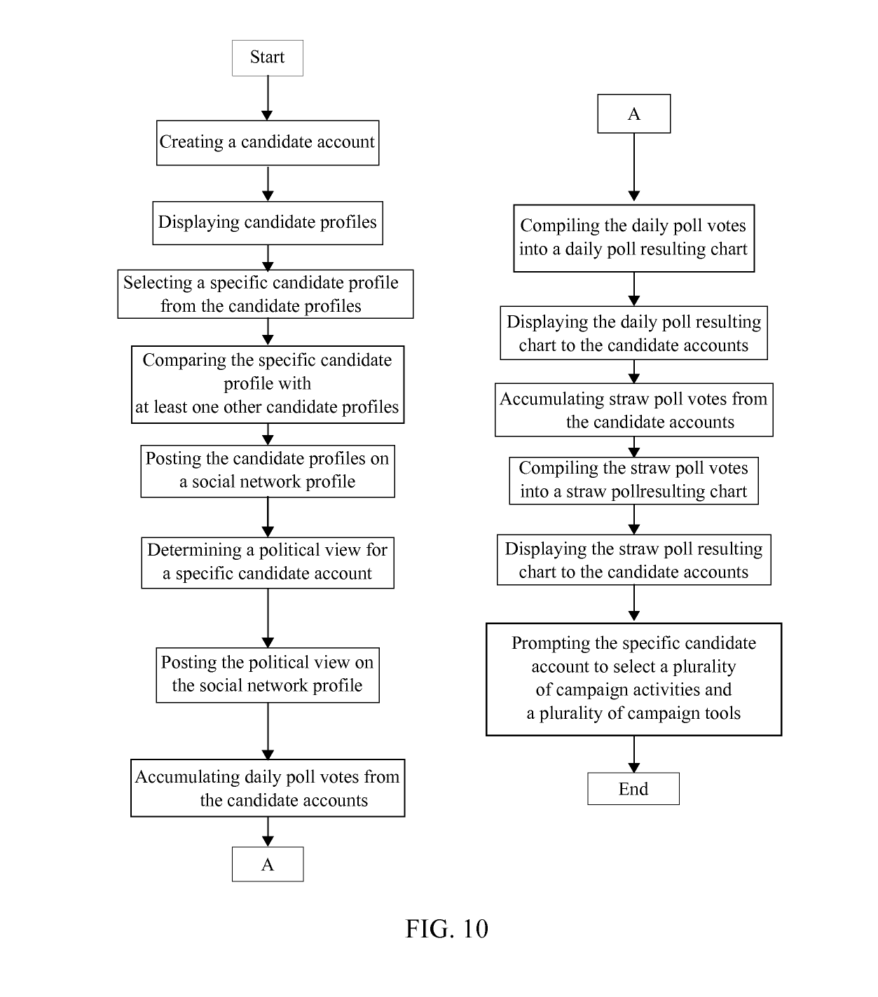

In reference to FIG. 1 and FIG. 10, the present invention provides an online application that combines social media with election service to create an ecosystem for voters, candidates, and interest groups. The present invention matches a voter with the perfect candidate for whom to vote in a similar way that dating sites match people by interest. The present invention amalgamates several data sources to provide information about the candidates combined with direct information provided by the candidates, political opponents, the interest groups, and the voters. In order to begin using the present invention, users need to log-in with a social network profile or sign-up for a user account though a graphic user interface. The user account can be a voter account or a candidate account. Moreover, the voter accounts belong to the voters and, the candidate accounts belong to the candidates. In reference to FIG. 2, during the sign-up process of creating a specific voter account, a specific voter needs to enter his or her personal information, a user name, a password, a favored political party, a plurality of favored political issues, whether the user is registered to vote, whether the user has interest in volunteering works, and privacy settings. The specific voter needs to rank the importance of the plurality of favored political issues by drag and drop order. The specific voter also needs to illustrate how staunch is his or her affiliation with the favored political party. The personal information comprises information such as full name, address, personal email, gender, and age. Once the specific voter completes the sign-up process, an activation notice is sent to the personal email of the specific voter and all of the entered information is saved into a database. Then the specific voter account can be activated through the activation notice. Since the social network profile of the specific voter is linked with the specific voter account, the specific voter can simply use the social network profile or the user name and the password to log-in.

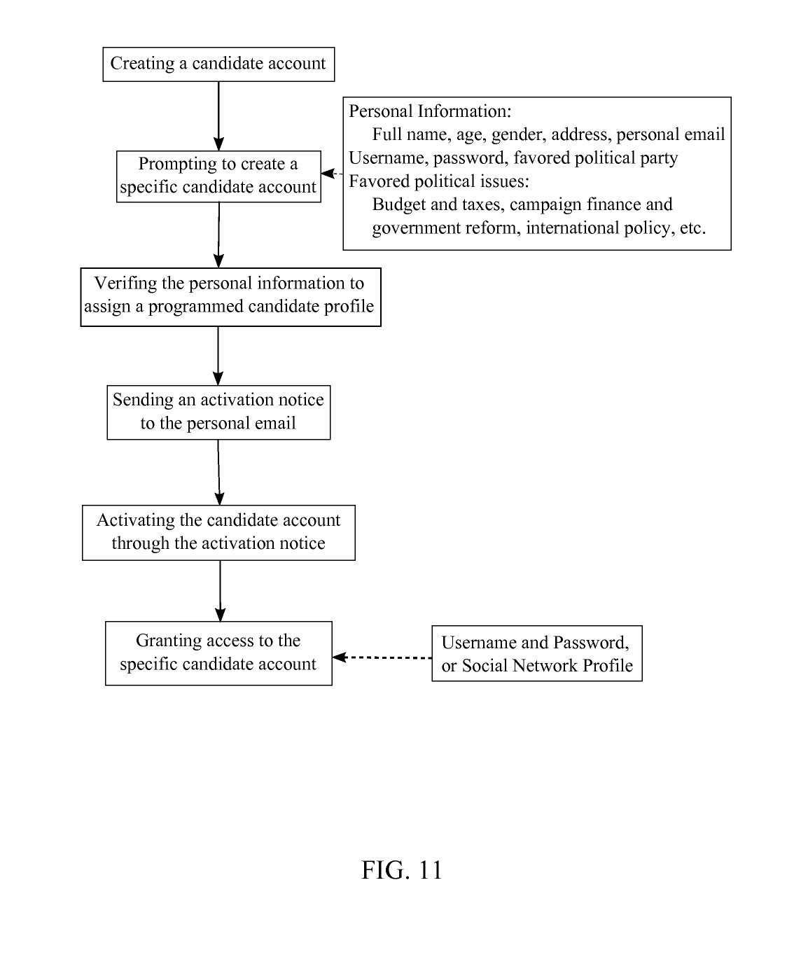

In reference to FIG. 11, the sign-up process of the candidate account is also similar to the sign-up process of the voter account. After the candidates finish the sign-up process, each of the candidates gains ownership to a specific candidate account. The candidate accounts are imported from authoritative sources and all of the imported information within the candidate accounts are strictly fact based and do not include any references or comparisons to other candidate accounts. Since the social network profile of a specific candidate is linked with the specific candidate account, the specific candidate can simply use the social network profile or the user name and the password to log-in.

If the voter or candidate forgets his or her password, a temporary password can be obtained through the present invention, and the temporary password is sent to the personal email. If the incorrect password is entered, the present invention displays a small message indicating that the incorrect password has been used.

The present invention allows for the selection of candidate profiles, a list of political questions, a daily changing political poll, straw polls, a plurality of campaign activities, and a plurality of campaign tools in the main menu of each of the user accounts. The voter accounts are able to view only the candidate profiles, the list of political questions, the daily changing political poll, the straw polls, and the plurality of campaign activities, while the candidate accounts are able to view the candidate profiles, the list of political questions, the daily changing political poll, the straw polls, the plurality of campaign activities, and the plurality of campaign tools.

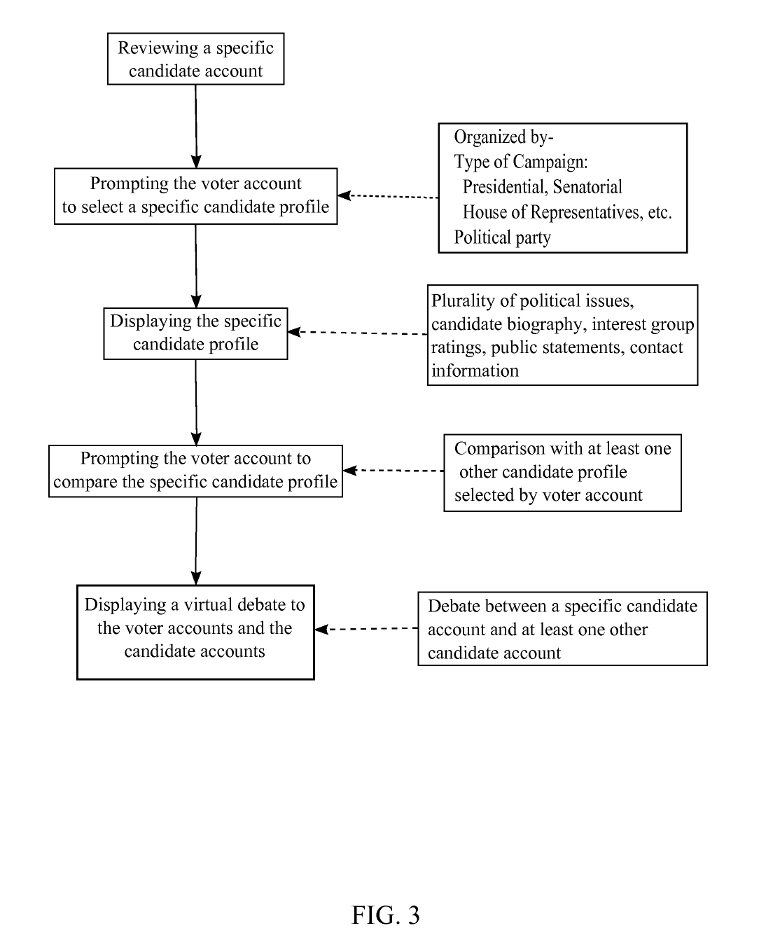

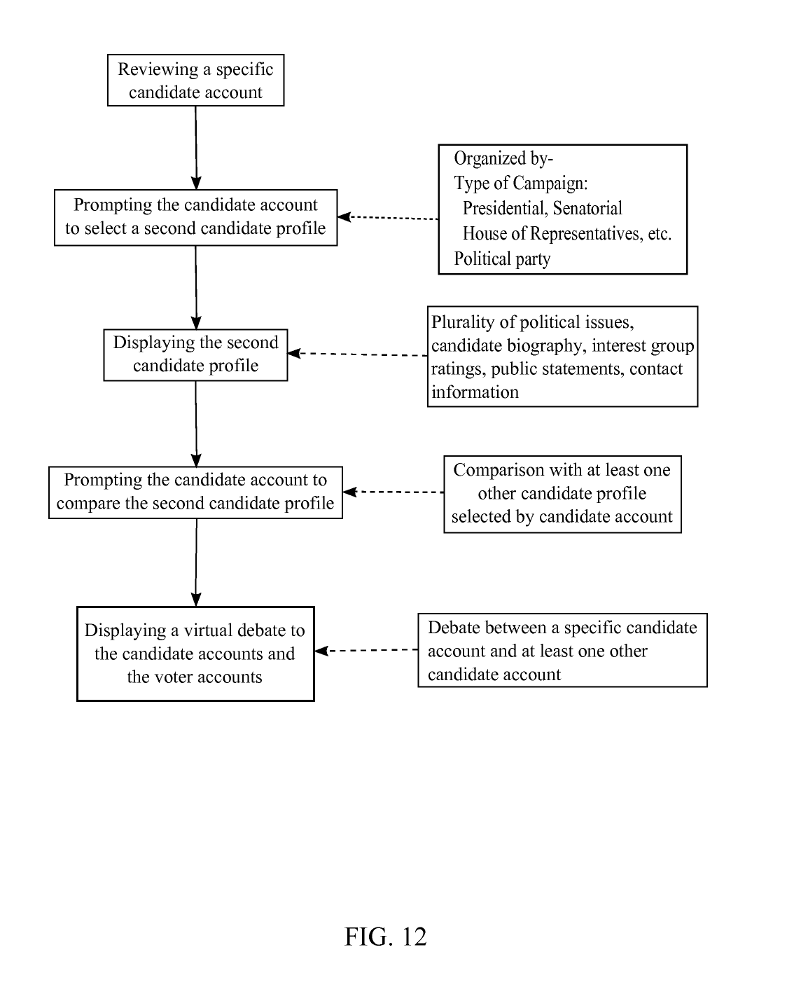

In reference to FIG. 3 and FIG. 12, the present invention allows the users to select a specific candidate profile from the candidate profiles to compare different candidates using a comparison option, and to view a virtual debate. To select the specific candidate profile, the users have to first select a type of campaign. For example, the type of campaign can be a presidential election, a senatorial election, a House of Representatives election, or any other type of political election. Then, the present invention prompts the users to select the specific candidate profile through the graphic user interface. The candidate profiles are organized according to political party for easy selection. The users can also select the specific candidate profile by entering the candidate's name in a search module. For example, when the users enter the candidate's name, the present invention lists the specific candidate profile that is associated with the candidate's name under the search module. The users also have the option to share the specific candidate profile through the social network profile. Once the users select the specific candidate profile, the present invention displays a picture of the candidate, a plurality of political issues, a candidate biography, interest group ratings, public statements, and candidate contact information in the graphic user interface.

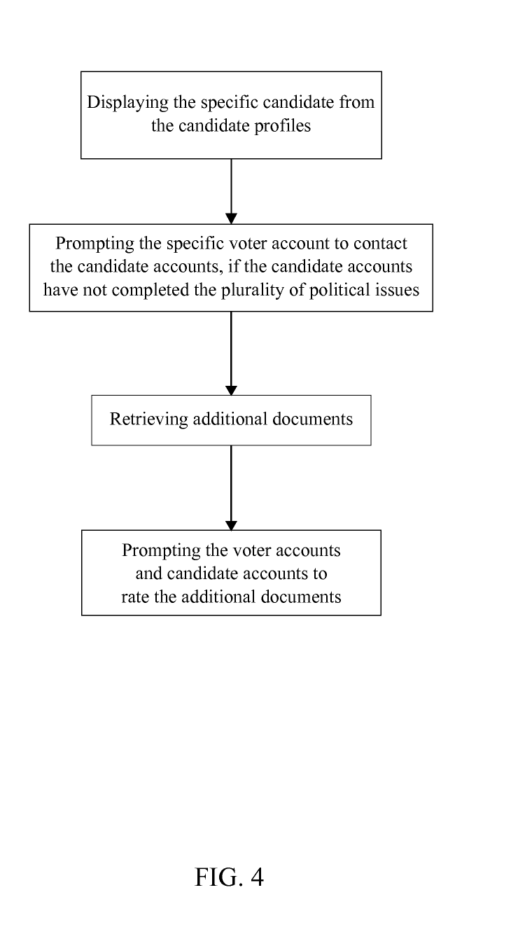

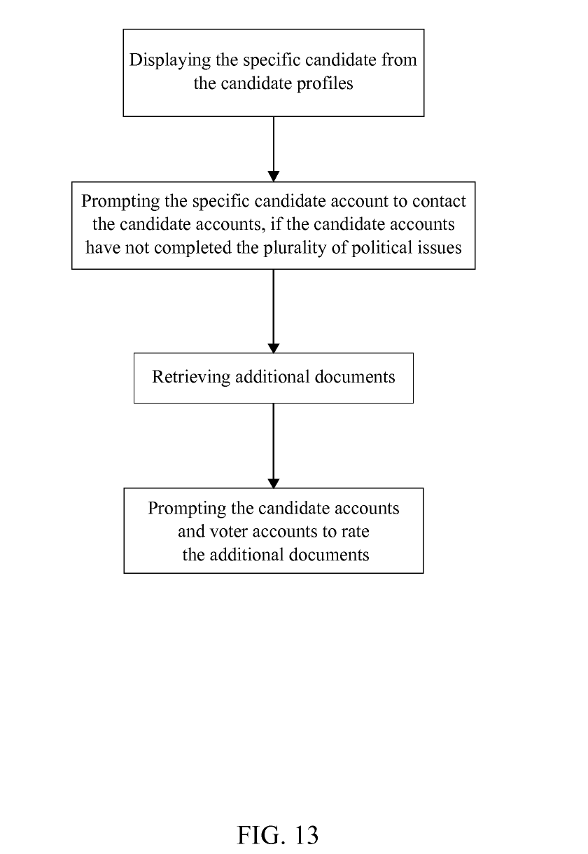

The plurality of political issues contains original questions from the political courage test, as well as the answers that the candidate provided in response. To make the candidate's stance on each of the plurality of political issues as accurate as possible, below the each of the plurality of political issues and the provided responses are user submitted additional documents that regard the candidate's position on the each of the plurality of political issues. The plurality of political issues comprises issues such as abortion issues, budget and taxes, campaign finance and government reform, crime issues, drug issues, educational issues, employment and affirmative action, environment and energy issues, gun issues, health issues, immigration issues, international policy and trade, national security issues, social security issues, technology issues, welfare and poverty issues, and legislative issues. The present invention displays a back button and an add source button while displaying the each of the plurality of political issues in the graphic user interface. The back button enables the users to navigate within the present invention. If the candidate has not completed the plurality of political issues, the present invention prompts a contact button in the graphic user interface. The contact button enables the users to contact the candidates so that the users can request the candidates to complete the plurality of political issues. In reference to FIG. 4 and FIG. 13, the present invention also prompts the users to upload the additional documents though the add source button. The users can upload the additional documents by filling out basic document information such as article title, article date, publication title, and a uniform resource locator (URL) to the article. Upon the completion of the basic document information, the present invention displays a submitted message informing the user that the additional documents were submitted. If any of the basic document information is not completed, the present invention displays a not submitted message informing the user that the additional documents are not submitted, and prompts the users to complete the basic document information. The uploaded additional documents are saved into the database by the present invention. The present invention enables the user to vote on the accuracy of the additional documents. The accuracy of the additional documents is rated by the users according to relevant votes, irrelevant votes, and inappropriate votes. The additional documents with a high number of relevant votes appear at the top of the list of the additional documents, while the additional documents with a high number of irrelevant votes are placed at the bottom of the list of the additional documents. The additional documents with inappropriate votes keep the additional documents away from the present invention, and accumulating at least twenty five inappropriate votes deletes the additional documents from the database.

The candidate biography displays information such as general information, background information, professional experience, political experience, and affiliated organizations. The general information comprises current office of the candidate, office seeking by the candidate, first elected date, last elected date, next election date, political party of the candidate, and other related general information regarding the candidate. The background information comprises gender, family information, birth date, birthplace, home city, religion, education, and other related background information. The professional experience comprises armed forces service and other relevant professional information. The political experiences comprise all of the political positions formerly held by the specific candidate. The organizations comprise a list of organizations with whom the specific candidate has been involved.

The present invention also displays the interest group ratings about the specific candidate. The interest group ratings are organized into a plurality of categories such as budget, spending and taxes, business and consumers, gun issues, and trading issues. Each of the plurality of categories comprises detailed information with reference to the specific candidate. The present invention also organizes all of the public statements made by the specific candidate where each of the public statements comprises a detailed statement description.

The candidate contact information comprises a plurality of web sites, a plurality of email addresses, a plurality of mailing addresses, a plurality of social media accounts, and a plurality of phone numbers. If the user wishes to contact the specific candidate, the users can simply tap the plurality of website URLs, the plurality of email addresses, the plurality of web accounts, or the plurality of phone numbers, which prompt the present invention to launch a plurality of default communication mediums.

The comparison option enables the users to compare the specific candidate profile with at least one other candidate profile with reference to the plurality of political issues, where the at least one other candidate profile can be from the same political party as the specific candidate or from opposed political parties. If the users decide to select the comparison option, the present invention displays the comparison between the specific candidate profile and the at least one other candidate profile with reference to the plurality of political issues. The present invention also enables the users to individually or completely delete the candidate profiles from the comparison option. At any point, if the specific candidate profile has not completed the plurality of political issues, the present invention prompts the users to contact the specific candidate profile. If the users decide to contact the specific candidate profile, the present invention accesses the candidate contact information. The comparison option provides a clear understanding of the different candidates to the voters, and the voters can also use the information for future elections.

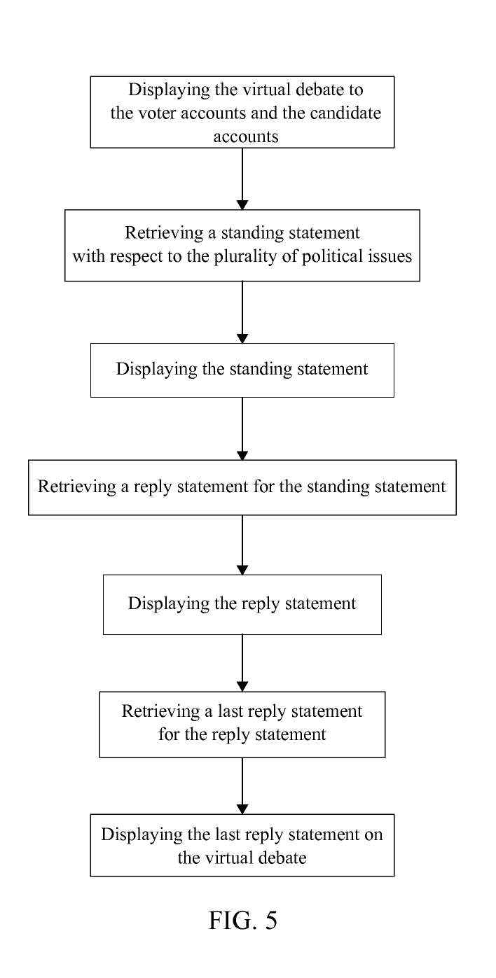

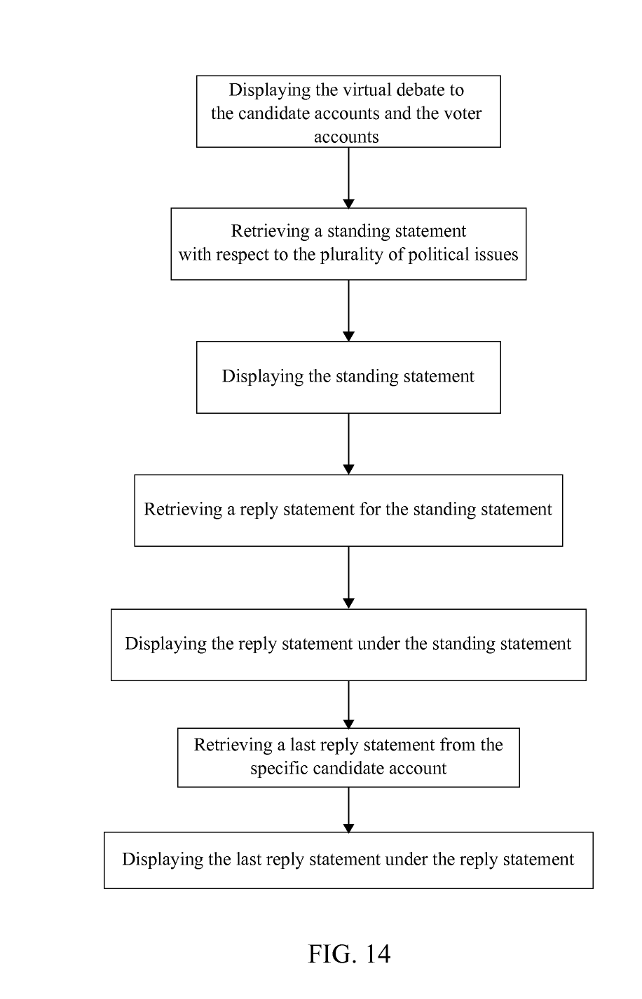

In reference to FIG. 5 and FIG. 14, the virtual debate is an online debate between the specific candidate account and at least one other candidate account where the specific candidate and the at least one other candidate have to competing in the same political race. The present invention enables the users to view the virtual debate where the user accounts are permitted to rate the accuracy of the virtual debate. The present invention retrieves a standing statement, with reference to the plurality of political issues, where the standing statement is entered by the specific candidate account and saved into the database. Then the standing statement is displayed on the virtual debate. The present invention prompts the at least one other candidate account to upload a reply statement. If the at least one other candidate account uploads the reply statement, the present invention retrieves the reply statement. The retrieved reply statement is then displayed in the virtual debate and saved to the database. Then the present invention prompts the specific candidate accounts to provide a last reply statement regarding the reply statement to the each of the candidate accounts. The standing statement, the reply statement, and the last reply statement would be character limited to encourage brevity and would have decreasing character limits with each iteration.

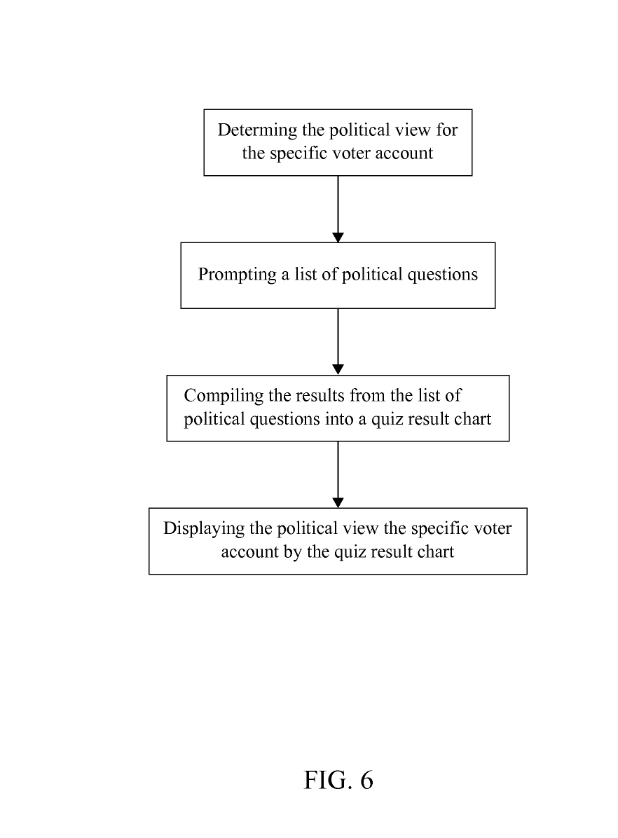

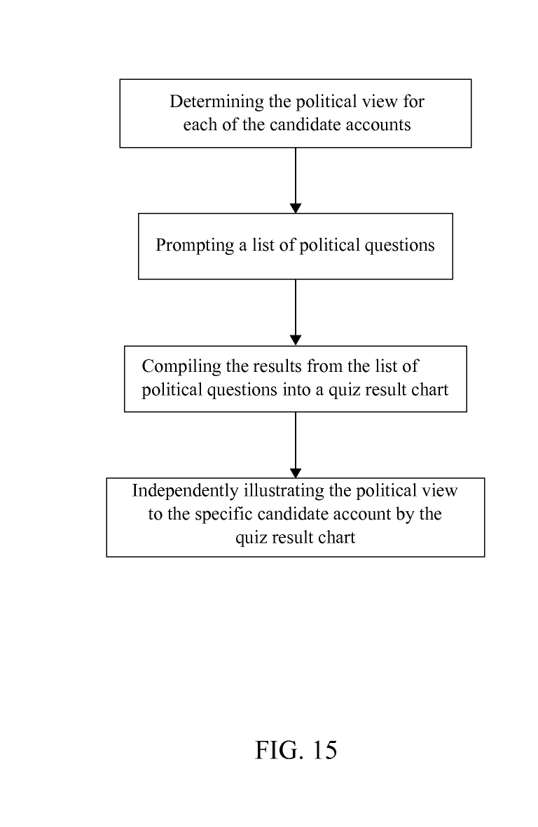

In reference to FIG. 6 and FIG. 15, the present invention determines a political view for the user account by prompting each of the user accounts to answer the list of political questions. Then, the answers are compiled together into a quiz result chart with reference to a personal issues score and an economic issues score. Since the each of the user accounts has different answers, the quiz result chart is independently displayed in the each of the user accounts. The quiz result chart displays the political view of the users according to different political views such as, liberalism, centrism, libertarianism, statist, and conservatism. The present invention also enables the users to post the quiz result chart in the social network profile. After posting the quiz result chart in the social network profile, other social network members are able to view the quiz result chart and a connecting link to the present invention. When the other social network members click the connecting link, the connecting link redirects the other social network members to the present invention and acts as a virtual marketing tool for the present invention for acquisition of new user accounts.

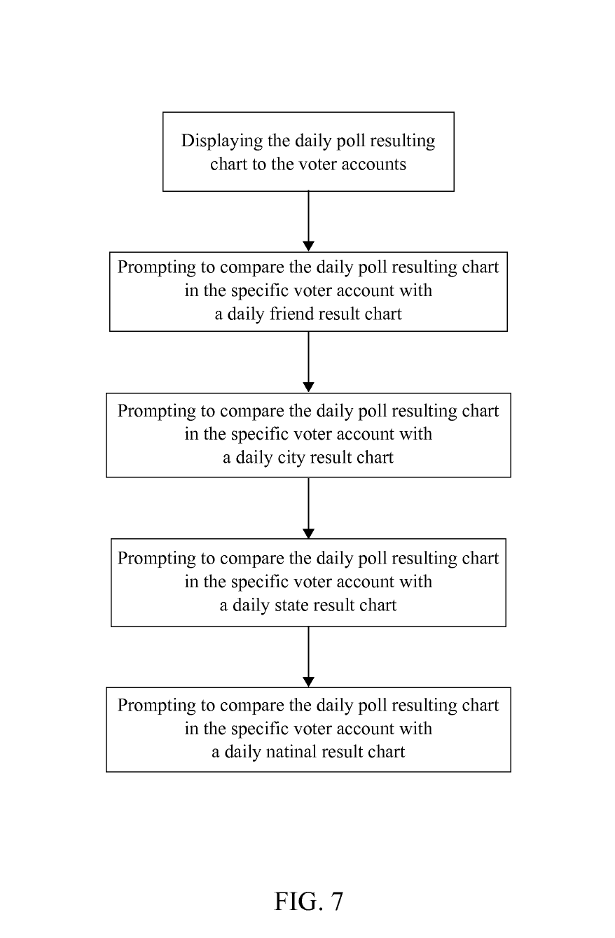

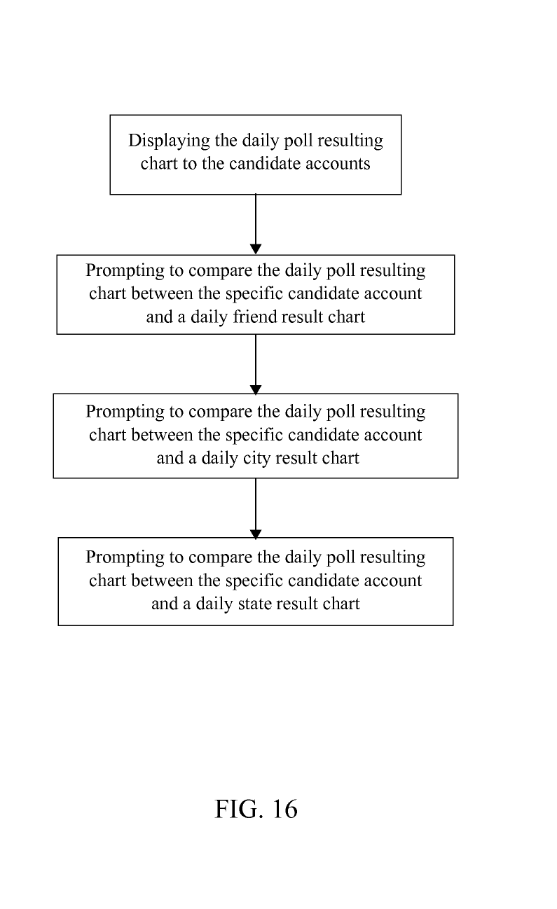

In reference to FIG. 7 and FIG. 16, the daily changing political poll contains a series of daily questions, wherein the series of daily questions change daily to gauge user sentiment. The present invention also enables the candidate accounts to purchase the series of daily questions. For example, if the specific candidate has questions regarding a particular issue and the specific candidate is seeking answers from the user accounts, the specific candidate can purchase web space within the present invention and post those questions as the series of daily questions. The present invention prompts the users to answer the series of daily questions and accumulate daily poll votes from the each of the user accounts where the daily poll votes are the submitted answers for the series of daily questions. Then, the present invention compiles the daily poll votes into a daily poll resulting chart and displays the daily poll resulting chart to the each of the user accounts. The present invention also enables the users to compare the daily poll resulting chart with a plurality of daily result charts where the plurality of daily result charts comprises a daily friend result chart, a daily city result chart, a daily state result chart, and a daily national result chart. The present invention enables the users to upload the daily poll resulting chart to the social network profile. The present invention also enables the users to upload the daily poll resulting chart with the daily friend result chart, the daily city result chart, the daily state result chart, and the daily national result chart to the social network profile.

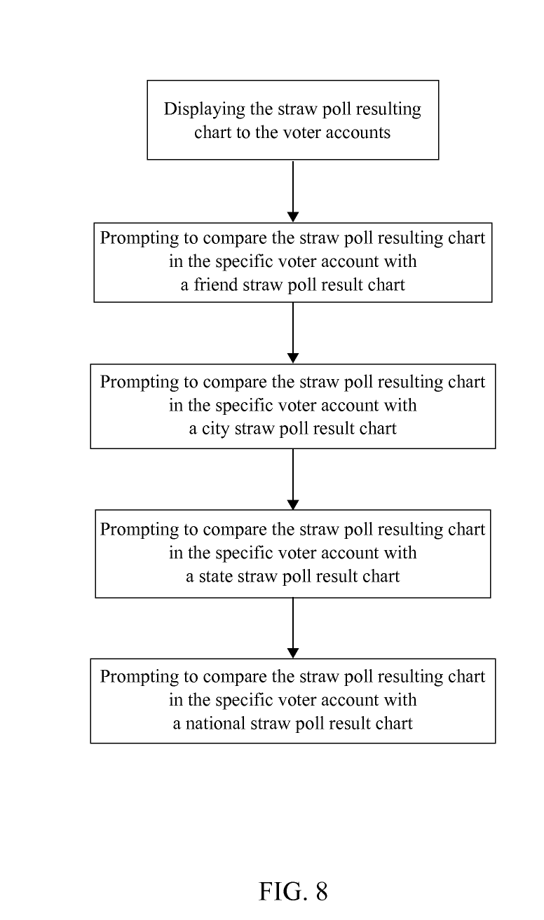

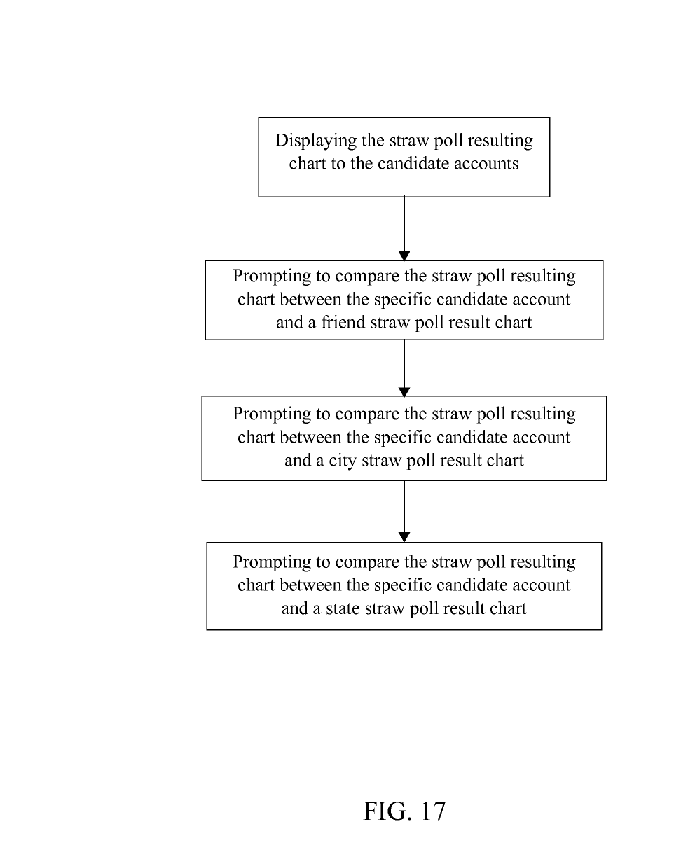

In reference to FIG. 8 and FIG. 17, the straw polls contain a faux election poll, wherein the faux election poll prompts the users to choose the specific candidate to gauge public opinion. The present invention prompts the users to answer the faux election poll, and accumulates straw poll votes from the each of the user accounts where the straw poll votes are the submitted answers for the faux election poll. Then the present invention compiles the straw poll votes into a straw poll resulting chart and displays the straw poll resulting chart to the each of the user accounts. The present invention also enables the users to compare the straw poll resulting chart with a plurality of straw poll result charts where the plurality of straw poll result charts comprises a friend straw poll result chart, a city straw poll result chart, a state straw poll result chart, and a national straw poll result chart. The present invention also enables the users to upload the straw poll resulting chart with the friend straw poll result chart, the city straw poll result chart, the state straw poll result chart, and the national straw poll result chart to the social network profile. The present invention enables the candidate accounts to purchase the plurality of daily result charts and the plurality of straw poll result charts with demographic breakdowns. The purchased plurality of daily result charts and the plurality of straw poll result charts don't display the personal information of the user accounts.

The present invention also displays a profile button and a sign out button through the graphic user interface. The profile button enables the users to edit the user accounts. When the users select the profile button, the present invention prompts a second window which comprises the personal information, the user name, the password, the favored political party, and the plurality of political issues. If the users decide not to edit the second window, they can simply select a cancel button. If the users decide to edit the second window, they can simply make changes through the graphic user interface. Once the users are finished editing the second window, the users can select a save button which saves all the new information to the database.

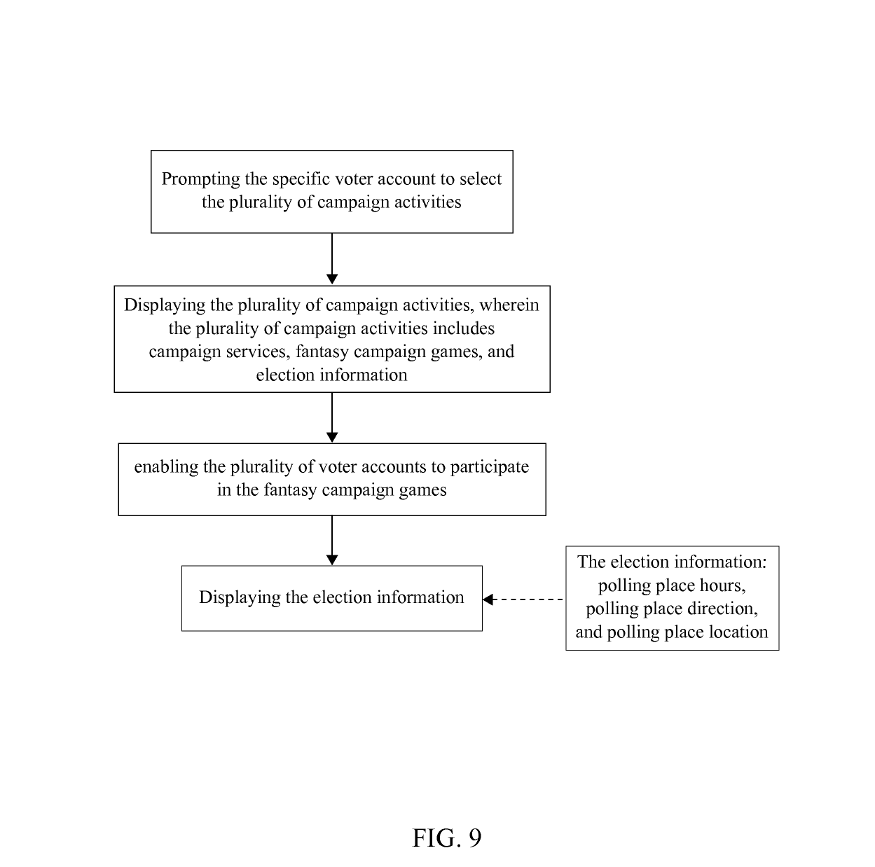

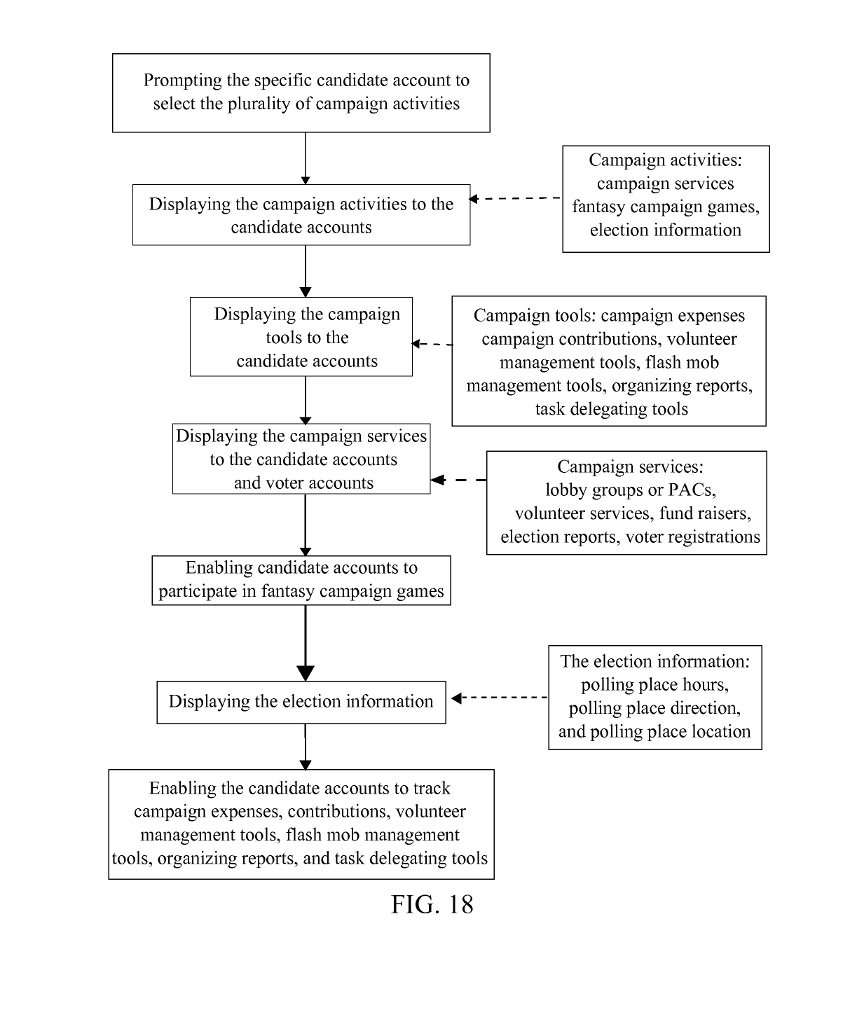

In reference to FIG. 9 and FIG. 18, the present invention displays the plurality of campaign activities to the user accounts, where the plurality of campaign activities comprises campaign services, fantasy campaign games, and election information. The campaign services comprise lobby groups or political action committees (PAC), volunteer service, fund raisers, election reports, and voter registration. The lobby groups or political action committees (PAC) help the voter accounts to engage in the political process, and the PACs can compete for ranking in various categories by member action and group activities. The lobby groups or political action committees (PAC) help the candidate accounts to interact with the voter accounts. The lobby groups or political action committees (PAC) enable the users to create public groups and private groups, choose officers, recruit members, raise money, demonstrate group achievements, compete with other groups, and hold virtual meetings. The volunteer service enables the voter accounts to offer unpaid assistance to the candidates while the volunteer service enables the candidate accounts seek for the unpaid assistance from the voters. The present invention prompts the voter accounts to set up the privacy settings, which are directly connected to the volunteer service, if the user has expressed interest in volunteering works during the sign-up process. The specific voter can decide who can contact him or her regarding the volunteer service by the privacy settings which comprises a public setting, a candidates setting, a limited setting, and a block setting. The public setting prompts all of the user accounts to contact the specific voter account, and the candidate setting prompts only the candidate accounts to contact the specific voter account. The limited setting prompts only a limited number of user accounts to contact the specific voter account where the limited number of user accounts is selected by the specific voter account. The block setting restricts all of the user accounts from contacting the specific voter account. The fund raisers can be organized by the voter accounts or the candidate accounts to raise money. The present invention prompts the user accounts to register for voting through the voter registration. The election reports comprise prior election results and current election results which can be displayed through the graphic user interface by the user accounts.

The present invention enables the user accounts to participate in the fantasy campaign games where the users receive fantasy achievements, fantasy badges, and a fantasy game score. The fantasy campaign games are web based and integrated with the social network profile. The election information comprises polling place hours, polling place directions, polling place locations, and ballots with selected candidates' names marked as “vote for”, and displayed to the user accounts by the present invention. The present invention displays the plurality of campaign tools only to the candidate accounts where the candidate accounts are able to view campaign expenses, campaign contributions, volunteer management tools, flash mob management tools, task delegating tools, and organizing reports.

The present invention operates using open standards, hyper text markup language (HTML), and java script. The present invention may also operate using OAuth 2.0. The present invention can also be used by political science classes as a helpful guide since the present invention combines most of the important political issues into one place.

The present invention strives to be unbiased towards any political party or ideology in order to provide a fact-based information source on all candidates. The present invention prompts the users to nominate a moderator. The moderator is also ranked by frame and can attain different titles. The moderator's actions are tracked and a record of the moderator's fairness is recorded to the database. Remarks and rebuttals in the present invention regarding voters and candidates are constantly looked over by the moderator to keep a system of self governance and community.

Although the invention has been explained in relation to its preferred embodiment, it is to be understood that many other possible modifications and variations can be made without departing from the spirit and scope of the invention as hereinafter claimed.

What is claimed is:

1. A method of combining voters and candidates through a non-transitory computer-readable medium by executing computer-executable instruction comprises the steps of:
providing a plurality of voter accounts, wherein each of the plurality of voter accounts include a voter profile;
providing a plurality of candidate accounts, wherein each of the plurality of candidate accounts includes a candidate profile;
providing a specific voter account and other voter accounts, wherein the plurality of voter accounts comprises the specific voter account and the other voter accounts;
linking the specific voter account with a social network profile;
displaying the candidate profile of each of the plurality of candidate account, wherein the candidate profile allows the specific voter account to gain knowledge about a specific candidate profile and compare the specific candidate profile with at least one other candidate profiles;
posting the candidate profiles on the social network profile by the specific voter account;
determining a political view for the each of the plurality of voter accounts;
posting the political view on the social network profile by the specific voter account;
accumulating daily poll votes from the each of the plurality of voter accounts, wherein the daily poll votes are the provided answers to a daily changing political poll;
compiling the daily poll votes into a daily poll resulting chart;
displaying the daily poll resulting chart to the each of the plurality of voter accounts, wherein the daily poll resulting chart allows the specific voter account to compare results with the plurality of candidate accounts and the plurality of voter accounts;
accumulating straw poll votes from each of the plurality of voter accounts, wherein the straw poll votes are the provided answers to a straw poll;
compiling the straw poll votes into a straw poll resulting chart;
displaying the straw poll resulting chart to each of the plurality of voter accounts, wherein the straw poll resulting chart allows the specific voter account to compare results with the plurality of candidate accounts and the plurality of voter accounts; and
prompting the specific voter account to select a plurality of campaign activities, wherein the plurality of campaign activities interact the specific voter with the plurality of candidates.

2. The method of combining voters and candidates through a non-transitory computer-readable medium by executing computer-executable instruction, the method as claimed in claim 1 further comprises the steps of:
prompting to create the specific voter account by entering personal information, a user name, a password, a favored political party, and a plurality of favored political issues;
sending an activation notice to the personal email of the specific voter account;
activating the specific voter account through the activation notice; and
granting access to the specific voter account through the user name and the password, or through the social network profile.

3. The method of combining voters and candidates through a non-transitory computer-readable medium by executing computer-executable instruction, the method as claimed in claim 1 further comprises the steps of:
prompting the specific voter account to select the specific candidate profile from the candidate profiles, wherein the candidate profiles are organized by the type of campaign and the political party;
displaying the specific candidate profile to the specific voter account, wherein the specific candidate profile include a plurality of political issues, a candidate biography, interest group ratings, public statements, and candidate contact information;
prompting the specific voter account to compare the specific candidate profile with the at least one other candidate profile, wherein the at least one other candidate profile is selected by the specific voter account; and
displaying a virtual debate to the plurality of voter accounts and to the plurality of candidate accounts, wherein the virtual debate is between a specific candidate account and the at least one other candidate account.

4. The method of combining voters and candidates through a non-transitory computer-readable medium by executing computer-executable instruction, the method as claimed in claim 3 further comprises the steps of:
prompting the specific voter account to contact the plurality of candidate accounts, if the plurality of candidate accounts have not completed the plurality of political issues;
comparing the specific candidate profile with the at least one other candidate profile with respect to the plurality of political issues;
retrieving additional documents to the plurality of political issues from the plurality of voter accounts and the plurality of candidate accounts, if the additional documents are absent in the plurality of political issues; and
prompting the plurality of voter accounts and the plurality of candidate accounts to rate the additional documents.

5. The method of combining voters and candidates through a non-transitory computer-readable medium by executing computer-executable instruction, the method as claimed in claim 3 further comprises the steps of:
retrieving a standing statement to the virtual debate from the specific candidate account;
displaying the standing statement on the virtual debate with respect to the plurality of political issues;
retrieving a reply statement for the standing statement from the at least one other candidate account;
displaying the reply statement on the virtual debate under the standing statement;
retrieving a last reply statement for the reply statement from the specific candidate account; and
displaying the last reply statement on the virtual debate under the reply statement.

6. The method of combining voters and candidates through a non-transitory computer-readable medium by executing computer-executable instruction, the method as claimed in claim 1 further comprises the steps of:
prompting the each of the plurality of voter accounts to answer a list of political questions;
compiling the results from the list of political questions into a quiz result chart; and
independently illustrating the political view of the each of the plurality of voter account by the quiz result chart.

7. The method of combining voters and candidates through a non-transitory computer-readable medium by executing computer-executable instruction, the method as claimed in claim 1 further comprises the steps of:
prompting to compare the daily poll resulting chart in the specific voter account with a daily friend result chart;
prompting to compare the daily poll resulting chart in the specific voter account with a daily city result chart;
prompting to compare the daily poll resulting chart in the specific voter account with a daily state result chart; and
prompting to compare the daily poll resulting chart in the specific voter account with a daily national result chart.

8. The method of combining voters and candidates through a non-transitory computer-readable medium by executing computer-executable instruction, the method as claimed in claim 1 further comprises the steps of:
prompting to compare the straw poll resulting chart in the specific voter account with a friend straw poll result chart;
prompting to compare the straw poll resulting chart in the specific voter account with a city straw poll result chart;
prompting to compare the straw poll resulting chart in the specific voter account with a state straw poll result chart; and
prompting to compare the straw poll resulting chart in the specific voter account with a national straw poll result chart.

9. The method of combining voters and candidates through a non-transitory computer-readable medium by executing computer-executable instruction, the method as claimed in claim 1 further comprises the steps of:
displaying the plurality of campaign activities to the each of the plurality of voter accounts, wherein the plurality of campaign activities includes campaign services, fantasy campaign games, and election information;
displaying the campaign services to the plurality of voter accounts, wherein the campaign services comprises lobby groups or political action committees (PAC), volunteer service, fund raisers, election reports, and voter registration;
enabling the plurality of voter accounts to participate in the fantasy campaign games; and
displaying the election information to the plurality of voter accounts and the plurality of candidate accounts, wherein the election information comprises polling place hours, polling place directions, and polling place locations.

10. A method of combining voters and candidates through a non-transitory computer-readable medium by executing computer-executable instruction comprises the steps of:
providing a plurality of candidate accounts, wherein each of the plurality of candidate accounts include a candidate profile;
providing a plurality of voter accounts, wherein each of the plurality of voter accounts include a voter profile;
providing a specific candidate account and other candidate accounts, wherein the plurality of candidate accounts comprises the specific candidate account and the other candidate accounts;
linking the specific candidate account with a social network profile;
displaying the candidate profile of each of the plurality of candidate account, wherein the candidate profile allows the plurality of voter accounts to gain knowledge about a specific candidate profile and compare the specific candidate profile with at least one other candidate profiles;
posting the candidate profiles on the social network profile by the specific candidate account;
determining a political view for the each of the plurality of candidate accounts;
posting the political view on the social network profile by the specific candidate account;
accumulating daily poll votes from the each of the plurality of candidate accounts, wherein the daily poll votes are the provided answers to a daily changing political poll;
compiling the daily poll votes into a daily poll resulting chart;
displaying the daily poll resulting chart to the each of the plurality of candidate accounts, wherein the daily poll resulting chart allows the specific candidate account to compare results with the plurality of candidate accounts and the plurality of voter accounts;
accumulating straw poll votes from each of the plurality of candidate accounts, wherein the straw poll votes are the provided answers to a straw poll;
compiling the straw poll votes into a straw poll resulting chart;
displaying the straw poll resulting chart to each of the plurality of candidate accounts, wherein the straw poll resulting chart allows the specific candidate account to compare results with the plurality of candidate accounts and the plurality of voter accounts; and
prompting the specific candidate account to select a plurality of campaign activities and a plurality of campaign tools, wherein the plurality of campaign activities and the plurality of campaign tools interact the specific candidate account with the plurality of voters regarding campaign management.

11. The method of combining voters and candidates through a non-transitory computer-readable medium by executing computer-executable instruction, the method as claimed in claim 10 further comprises the steps of:
prompting to create the specific candidate account by entering personal information, a user name, a password, a favored political party, and a plurality of favored political issues;
verifying the personal information in order to assign a programmed candidate profile, wherein the programmed candidate profile is entered by an administrative team;
sending an activation notice to the personal email of the specific candidate account;
activating the specific candidate account through the activation notice; and
granting access to the specific candidate account through the user name and the password or through the social network profile.

12. The method of combining voters and candidates through a non-transitory computer-readable medium by executing computer-executable instruction, the method as claimed in claim 10 further comprises the steps of:
prompting the specific candidate account to select a second candidate profiles from the candidate profiles, wherein the candidate profiles are organized by the type of campaign and the political party;
displaying the second candidate profile to the specific candidate account, wherein the second candidate profile include a plurality of political issues, a candidate biography, interest group ratings, public statements, and candidate contact information;
prompting the specific candidate account to compare the second candidate profile with the at least one other candidate profile, wherein the at least one other candidate profile is selected by the specific candidate account; and
displaying a virtual debate to the plurality of candidate accounts and the plurality of voter accounts, wherein the virtual debate is between the specific candidate account and the at least one other candidate account.

13. The method of combining voters and candidates through a non-transitory computer-readable medium by executing computer-executable instruction, the method as claimed in claim 12 further comprises the steps of:
prompting the specific candidate account to contact the plurality of candidate accounts, if the plurality of candidate accounts have not completed the plurality of political issues;
comparing the specific candidate profile with the at least one other candidate profile with respect to the plurality of political issues;
retrieving additional documents to the plurality of political issues from the plurality of candidate accounts and the plurality of voter accounts, if the additional documents are absent in the plurality of political issues; and
prompting the plurality of candidate accounts and the plurality of voter accounts to rate the additional documents.

14. The method of combining voters and candidates through a non-transitory computer-readable medium by executing computer-executable instruction, the method as claimed in claim 12 further comprises the steps of:
retrieving a standing statement to the virtual debate from the specific candidate account;
displaying the standing statement on the virtual debate with respect to the plurality of political issues;
retrieving a reply statement for the standing statement from the at least one other candidate account;
displaying the reply statement on the virtual debate under the standing statement;
retrieving a last reply statement for the reply statement from the specific candidate account; and
displaying the last reply statement on the virtual debate under the reply statement.

15. The method of combining voters and candidates through a non-transitory computer-readable medium by executing computer-executable instruction, the method as claimed in claim 10 further comprises the steps of:
prompting the each of the plurality of candidate accounts to answer a list of political questions;
compiling the results from the list of political questions into a quiz result chart; and
independently illustrating the political view of the each of the plurality of candidate account by the quiz result chart.

16. The method of combining voters and candidates through a non-transitory computer-readable medium by executing computer-executable instruction, the method as claimed in claim 10 further comprises the steps of:
prompting to compare the daily poll resulting chart in the specific candidate account with a daily friend result chart;
prompting to compare the daily poll resulting chart in the specific candidate account with a daily city result chart;
prompting to compare the daily poll resulting chart in the specific candidate account with a daily state result chart; and
prompting to compare the daily poll resulting chart in the specific candidate account with a daily national result chart.

17. The method of combining voters and candidates through a non-transitory computer-readable medium by executing computer-executable instruction, the method as claimed in claim 10 further comprises the steps of:
prompting to compare the straw poll resulting chart in the specific candidate account with a friend straw poll result chart;
prompting to compare the straw poll resulting chart in the specific candidate account with a city straw poll result chart;
prompting to compare the straw poll resulting chart in the specific candidate account with a state straw poll result chart; and
prompting to compare the straw poll resulting chart in the specific candidate account with a national straw poll result chart.

18. The method of combining voters and candidates through a non-transitory computer-readable medium by executing computer-executable instruction, the method as claimed in claim 10 further comprises the steps of:
displaying the plurality of campaign activities to the each of the plurality of candidate accounts, wherein the plurality of campaign activities includes campaign services, fantasy campaign games, and election information;
displaying the plurality of campaign tools to the each of the plurality of candidate accounts, wherein the plurality of campaign tools includes campaign expenses, campaign contributions, volunteer management tools, flash mob management tools, organizing reports, and task delegating tools;
displaying the campaign services to the plurality of candidate accounts and to the plurality of voter accounts, wherein the campaign services comprises lobby groups or political action committees (PAC), volunteer service, fund raisers, election reports, and voter registration;
enabling the plurality of candidate accounts to participate in the fantasy campaign games;
displaying the election information to the plurality of candidate accounts and to the plurality of voter accounts, wherein the election information comprises polling place hours, polling place directions, and polling place locations; and
enabling the plurality of candidate accounts to track the campaign expenses, the campaign contributions, the volunteer management tools, flash mob management tools, the organizing reports, and the task delegating tools.
